(19) United States
(12) Patent Application Publication
(10) Pub. No.: US 2013/0319081 A1
(43) Pub. Date: Dec. 5, 2013

(54) GAS CONCENTRATION METER

(71) Applicant: BIOTEST MEDICAL CORPORATION, Taichung City (TW)

(72) Inventor: Tony CHENG, TAICHUNG CITY (TW)

(73) Assignee: BIOTEST MEDICAL CORPORATION, TAICHUNG CITY (TW)

(21) Appl. No.: 13/669,483

(22) Filed: Nov. 6, 2012

(30) Foreign Application Priority Data
Jun. 4, 2012 (TW) 101210732

(51) Int. Cl. G01N 27/00

(52) U.S. Cl. 73/31.05

(57) ABSTRACT

A gas concentration meter includes a meter body having a control circuit and a gas concentration sensor accommodated therein and electrically connected together said control circuit board and a gas passage extending through the gas concentrations sensor, and a fan unit mounted at one side of the meter body and having a fan blade rotatably mounted inside an annular peripheral wall thereof. The gas passage has its one end terminating in an inlet and extends to an inner side of the annular peripheral wall. When a gas flow goes through the fan unit to rotate the fan blade, a part of the gas flow will enter the inlet of the gas passage, enhancing measuring accuracy and shortening the reaction time of the gas concentration sensor. Further, a wind speed sensor may be provided to measure flow velocity.

### BACKGROUND OF THE INVENTION

1. Field of the Invention

The present invention relates to gas concentration measuring technology and more particularly, to a gas concentration meter, which uses the intake gas flow to rotate a fan blade, enabling a part of the intake gas flow to be steadily forced by the rotating fan blade into the inside of the meter so that measurement errors can be reduced.

2. Description of the Related Art

Due to the need of modern city life and work, a lot of people are often gathered in one same building, easily leading to a dangerous high level of indoor carbon dioxide concentration Inhaling too much carbon dioxide will lead to a slowdown of the brain activities, unresponsiveness, or the state of drowsiness and lethargy. Therefore, gas sensors may be installed to in buildings to measure the concentration of carbon dioxide, making sure that indoor ventilation function is normal.

Conventional gas concentration measurement devices commonly comprise a meter and a detector head. When putting a gas concentration measurement device in the environment to be measured, the gas to be measured enters the detector head by means of gas diffusion, and the detector head can then measure the concentration of the intake gas, enabling the measured data to be displayed on the meter. However, this gas concentration measuring method is not suitable for measuring the concentration of a gas in a complex and highly variable flow field around the detector head, and can easily lead to measurement errors. Improvement in this regard is necessary.

### SUMMARY OF THE INVENTION

The present invention has been accomplished under the circumstances in view. It is the main object of the present invention to provide a gas concentration meter, which uses the intake gas flow to rotate a fan blade, enabling a part of the intake gas flow to be steadily guided into the inside of the meter so that measurement errors can be reduced.

To achieve this and other objects of the present invention, a gas concentration meter comprises a meter body and a fan unit. The meter body comprises a control circuit board and gas concentration sensor accommodated therein and electrically connected together, and a gas passage extending through the gas concentration sensor. The gas passage has its one end terminating in an inlet, and its other end terminating in an outlet. The fan unit is mounted at one side of the meter body, comprising an annular peripheral wall, and a fan blade rotatably mounted inside the annular peripheral wall. Further, the inlet of the gas passage extends to the inner side of the annular peripheral wall.

Thus, when a gas flow goes through the fan unit to rotate the fan blade, a part of the gas flow will be forced by the rotating fan blade into the inlet of the gas passage. In addition to the advantage of faster inflow velocity than conventional gas diffusion, the invention avoids the interference of a complex flow field and improves the measurement accuracy.

Further, in one preferred embodiment of the present invention, a wind speed sensor is mounted inside the annular peripheral wall of the fan unit to measure the flow velocity during measurement of the gas concentration. The wind speed sensor comprises an emitter and a receiver respectively disposed at two opposite sides relative to the fan blade.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique front elevational view of a gas concentration meter in accordance with the present invention.

FIG. 2 is a longitudinal sectional view of the gas concentration meter in accordance with the present invention.

FIG. 3 is an elevational view of a part of the present invention, illustrating the arrangement of the blades of the fan unit.

### DETAILED DESCRIPTION OF THE INVENTION

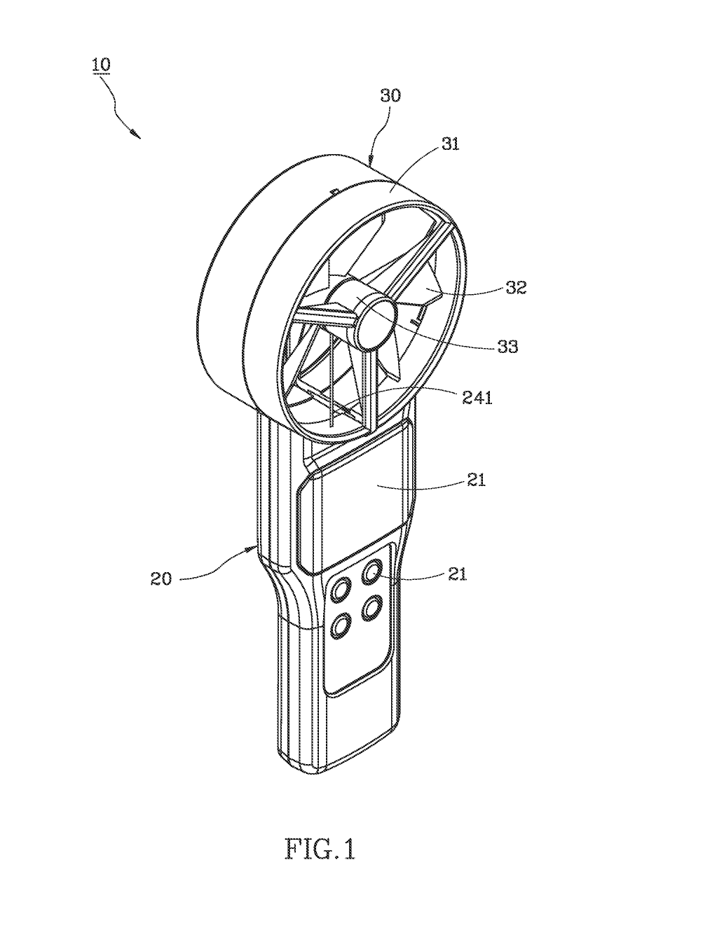

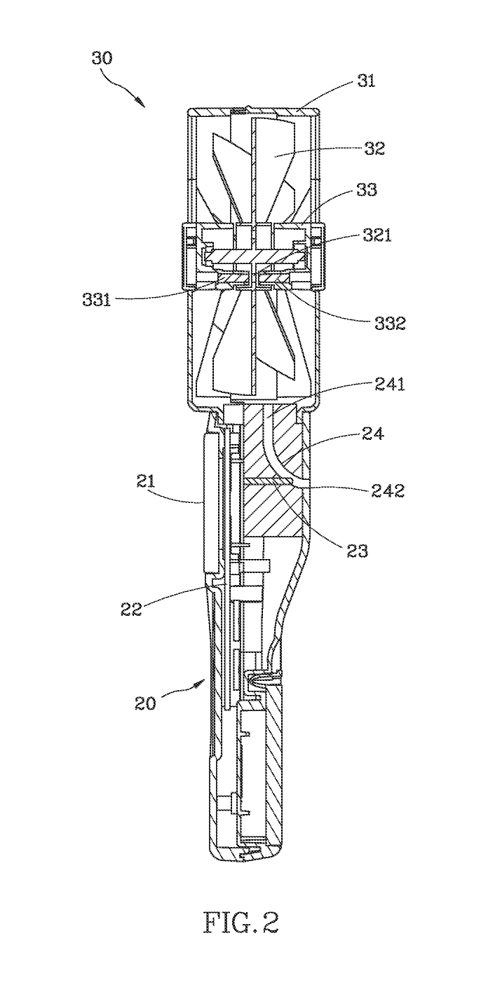

Referring to FIGS. 1 and 2, a gas concentration meter 10 in accordance with the present invention is shown for measuring the gas concentration of a gas flow. The gas concentration meter 10 comprises a meter body 20, and a fan unit 30 disposed at one side of the meter body 20.

The meter body 20 comprises a user interface 21 consisting of a screen and a set of operating keys, a control circuit board 22 accommodated therein, a gas concentration sensor 23 accommodated therein and electrically connected to the control circuit board 22, and a gas passage 24 extending through the gas concentration sensor 23. The gas passage 24, as shown in FIG. 2, has its one end terminating in an inlet 241 that is disposed in communication with the inside space of the fan unit 30, and its other end terminating in an outlet 242 that is located on the outside wall of the meter body 20 far from the user interface 21.

The fan unit 30 comprises an annular peripheral wall 31, a fan blade 32 rotatably mounted inside the annular peripheral wall 31, and a wind speed sensor 33 mounted inside the annular peripheral wall 31. The inlet 241 of the gas passage 24 extends to the inner side of the annular peripheral wall 31. When a gas flow goes through the fan unit 30 to rotate the fan blade 32, a part of the gas flow will be forced by the rotating fan blade 32 toward the annular peripheral wall 31, and therefore a part of the gas flow will go into the inlet 241 of the gas passage 24 toward the gas concentration sensor 23 and then to the outside of the meter body 20 through the outlet 242.

The gas concentration sensor 23 can measure the concentration of one specific gas or multiple specific gases. Subject to different application requirements, the gas concentration sensor 23 can be designed to measure the concentration of, for example, but not limited to, oxygen, carbon monoxide, carbon dioxide, nitric oxide, nitrogen dioxide, hydrogen sulfide, hydrogen chloride, sulfur dioxide, hydrocarbons, ammonia and/or particles.

When a sample gas flow goes through the gas passage 24, the gas concentration sensor 23 provides sensed data to the control circuit board 22, enabling the data to be displayed on the screen of the user interface 21.

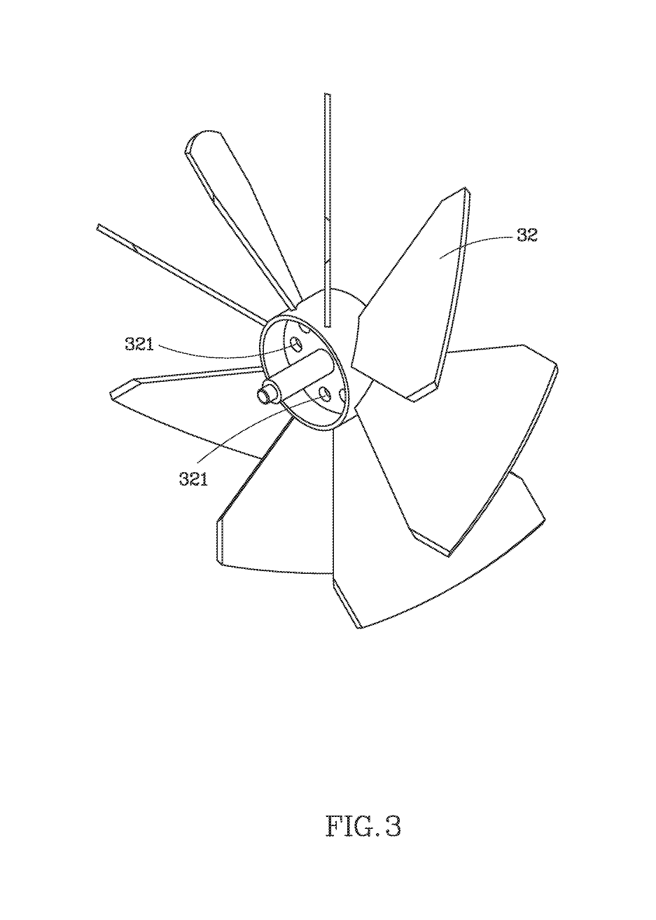

Further, the fan blade 32 of the fan unit 30 has a plurality of through holes 321, as shown in FIG. 3. Further, the wind speed sensor 33 comprises an emitter 331 and a receiver 332 respectively disposed at two opposite sides relative to the through holes 332 and electrically connected to the control circuit board 22. Thus, when the fan unit 32 is forced to rotate by a gas flow, the emitter 331 emits infrared light that goes intermittently through the through holes 321 to the receiver 332. Subject to the time interval of the infrared light passing through the fan blade 32, the control circuit board 22 calculates the rotational speed of the fan blade 32, and then uses the data of the rotational speed of the fan blade 32 and the cross-sectional area of the annular peripheral wall 31 to calculate the flow velocity and flow rate of the gas flow.

Based on the aforesaid structure, when the gas concentration meter 10 is placed indoors or in a gas exit, gas flow entering the fan unit 30 will rotate the fan blade 32, and a part of the intake gas flow will be forced by the rotating fan blade 32 into the gas passage 24, enabling the gas concentration sensor 23 to sense the concentration of a particular gas in the intake gas flow, and therefore, the invention can effectively enhance the measuring accuracy and shorten the reaction time of the gas concentration sensor. Further, in addition to gas concentration measurement, the wind speed sensor 33 can also measure the flow velocity of the gas flow for calculating the flow rate using the cross-sectional area of the annular peripheral wall 31. Thus, the practicality of the gas concentration meter 10 is enhanced.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A gas concentration meter, comprising:
a meter body comprising a control circuit board accommodated therein, a gas concentration sensor accommodated therein and electrically connected to said control circuit board, and a gas passage extending through said gas concentrations sensor, said gas passage having one end thereof terminating in an inlet and an opposite end thereof terminating in an outlet; and
a fan unit mounted at one side of said meter body, said fan unit comprising an annular peripheral wall, and a fan blade rotatably mounted inside said annular peripheral wall;
wherein said inlet of said gas passage extends to an inner side of said annular peripheral wall.

2. The gas concentration meter as claimed in claim 1, further comprising a wind speed sensor mounted inside said annular peripheral wall of said fan unit.

3. The gas concentration meter as claimed in claim 2, wherein said fan blade comprises at least one through hole; said wind speed sensor comprising an emitter and a receiver disposed at two opposite sides relative to said at least one through hole of said fan blade and electrically connected to said control circuit board.

4. The gas concentration meter as claimed in claim 1, 2 or 3, wherein said meter body further comprises a user interface formed of a screen and a set of operating keys.

5. The gas concentration meter as claimed in claim 4, wherein said outlet of said gas passage is located on one side of said meter body far from said user interface.
